(19) United States
(12) Patent Application Publication
(10) Pub. No.: US 2009/0311368 A1
(43) Pub. Date: Dec. 17, 2009

(54) Biodegradable toffee gum

(76) Inventor: Helle Wittorff, Vejle Ost (DK)

Correspondence Address: ST. ONGE STEWARD JOHNSTON & REENS, LLC, 986 BEDFORD STREET, STAMFORD, CT, 06905-5619, US

(21) Appl. No.: 11/919,958

(22) PCT Filed: May 4, 2005
(86) PCT No.: PCT/DK2005/000305

§ 371 Date: Nov. 5, 2007

(51) Int. Cl. A23G 4/06; A23G 4/18; A23G 4/10; A23G 4/20; A23G 4/08

(52) U.S. Cl. 426/5; 426/3

(57) ABSTRACT

The invention relates to a toffee gum comprising a polymer system, at least one flavor, and at least one sweetener, said polymer system constituting at least 10% by weight of said toffee gum, at least 70% by weight of said polymer system comprising one or more at least partly biodegradable polymers, and at least one of said at least partly biodegradable polymers having a molecular weight (Mn) in the range of 1000 to 250000 g/mol.

### FIELD OF THE INVENTION

The invention relates to a biodegradable toffee gum according to claim 1.

### BACKGROUND OF THE INVENTION

A group of conventional confectionery products include tablet-formed and chewable substances, which may be gradually dissolved or chewed and digested, such as candy, jelly, wine gum, liquorice, toffee, etc. This group of confectionery products generally benefits of a large variety of applicable textures, as indicated by the above-mentioned different products.

A problem related to this group of confectionery products, such as e.g. liquorice, toffee, etc, is that these products are consumed relatively fast, so that the consumer repeatedly needs to reload. This may lead to over-consuming, which may be undesirable due to a large intake of calories. In recent years, much attention has been paid to this problem. However, too large calorie-intake due to large consumption of confectionery products seems to be an increasing problem in some countries.

### SUMMARY OF THE INVENTION

The present invention relates to a toffee gum comprising a polymer system, at least one flavor, and at least one sweetener,

said polymer system constituting at least 10% by weight of said toffee gum,

at least 70% by weight of said polymer system comprising one or more at least partly biodegradable polymers, and

at least one of said at least partly biodegradable polymers having a molecular weight (Mn) in the range of 1000 to 250000 g/mol.

According to the invention, a part of a toffee may be substituted by a polymer system of one or several polymers. In this way, prolonged taste and texture may be obtained together with a texture corresponding to the desired toffee texture.

The prolonged texture is obtained by way of the polymer system, as the polymers are not digested during chewing but rather forming part of a toffee-emulating polymer structure, which may be chewed in the same way as a chewing gum.

The prolonged taste may be obtained due to the fact that some of the taste-providing substances are incorporated into the polymer system, both by initial mixing during manufacturing and/or by mixing occurring during the chew-process performed by a consumer.

According to the present invention, a confectionery product has been provided, which possesses toffee-like properties, but which is not completely swallowed during use. In order to obtain the desired prolonged texture, the polymer system constitutes above about 10% by weight of the toffee gum product.

Surprisingly, it has been found that a row of biodegradable polymers possess such properties essential to imitate the textural properties of toffee and obtain a toffee gum product having properties resembling or emulating toffee. The toffee-like properties may be maintained for a relatively long time, e.g. 10-20 minutes, compared to chewing of a conventional toffee, which is usually swallowed during a shorter period of time.

According to the invention, it is a key feature of the toffee gum confectionery product that it comprises a polymer system of which at least 70%, preferably more than 70%, by weight is composed of at least partly biodegradable polymers. The biodegradability of the polymers may according to the invention considerably reduce undesired environmental problems resulting from residues from the toffee gum. According to the invention, the residue of the toffee gum being left, when the consumer decides to stop chewing the toffee gum, may be formed mainly of biodegradable polymers, which are degraded in the environment after the toffee gum residue is dumped.

A further, very advantageous feature of the invention is that the toffee-like texture is combined with an improved robustness to e.g. fats. Thus, chocolate fillings or coatings may be applied within the scope of the invention.

Herein, the polymer system is used as a term covering the polymers applied in the toffee gum confectionery product according to the invention. The polymer system may comprise one or more types of polymers. Other ingredients, such as fillers, softeners, etc. should not be regarded as being part of the polymer system.

According to the present invention, a new biodegradable confectionery product has been obtained having texture properties emulating toffee but comprising a part, which is retained in the mouth during chewing. This confectionery product according to the invention is referred to as ‘toffee gum’.

A polymer based or polymer supplemented toffee texture is thus advantageously obtained having properties emulating toffee although polymers may actually form a significant part of the toffee gum.

According to a preferred embodiment of the invention, a toffee gum may be a suitable substitute for conventional toffee or caramel, as the toffee gum is provided with texture properties resembling toffee and caramel. Toffee gum as a substitute for toffee, caramel, and further soft candies such as liquorice has the advantage of being a low-calorie substitute, which moreover provides a prolonged taste sensation.

In an embodiment of the invention, said polymer system is substantially free of elastomers.

According to an embodiment of the invention, the toffee gum confectionery product may be provided with the desired toffee-like texture on the basis of a polymer system, in which all the polymers comprised are substantially non-elastomeric biodegradable polymers and none of them are elastomers.

In an embodiment of the invention, said polymer system constitutes at least 12% by weight of said toffee gum.

In order to obtain the desired prolonged texture, the polymer system preferably constitutes above about 12% by weight of the toffee gum product

In an embodiment of the invention, said polymer system constitutes in the range of 15% to 95%, preferably 20% to 85%, more preferably 25% to 75%, and most preferably 30% to 65% by weight of said toffee gum.

The quantity of polymer system in a toffee gum according to the invention may be regulated in order to obtain a certain desired balance between substance retained in the mouth when consuming the product and substance being swallowed by the user.

The applied amount of polymer system furthermore affects the consistency of the product in combination with further ingredients such as softeners, sweeteners and flavors.

According to an embodiment of the invention, the amount of polymer system is regulated within the range of 30 to 65 weight percent of the toffee gum. If the percentage of polymer system is too low, it may cause difficulty with the coherence and shape of the product. On the other hand, if the percentage of polymer system is too high, it may cause the product to be less tasty and more tiring to consume and chew.

In an embodiment of the invention, said polymer system comprises at least one non-elastomeric polymer.

According to an embodiment of the invention, most of the polymers in the polymer system applied in the toffee gum are non-elastomeric. Thus, application of polymers, which are resinous rather than elastomers is preferred, as these polymers have been found to be essential components in order to emulate the texture of toffee.

In an embodiment of the invention, said polymer system comprises at least one elastomeric polymer.

Although, elastomers are generally not preferred and should never constitute the largest part of the polymer system according to the present invention, a smaller percentage of elastomers may be applied in order to adjust the texture of the toffee gum product according to the present invention.

In an embodiment of the invention, said at least one non-elastomeric polymer constitutes in the range of 70% to 100%, preferably 80% to 100% by weight of said polymer system.

In an embodiment of the invention, said at least one elastomeric polymer constitutes in the range of 0% to 30%, preferably 0% to 20% by weight of said polymer system.

In an embodiment of the invention, said at least one elastomeric polymer has a molecular weight in the range of 10000 to 500000 g/mol, preferably in the range of 20000 to 100000 g/mol.

In an embodiment of the invention, said polymer system comprises polymers having a molecular weight (Mn) from about 50000 to 250000 g/mol in an amount of less than 8% by weight of said polymer system.

Thus, according to an embodiment of the invention, polymers of molecular weight above about 50000 g/mol may only be applied in amounts of less than 8% by weight of the polymer system. It is undesirable to increase the amount further, because such higher molecular weight polymers may have properties as elastomers. If the elastomeric part of the polymer system is too large, the toffee gum product may show texture properties similar to typical chewing gum-texture, and thereby the desired toffee-like texture according to the invention, may be lost. With higher molecular weights, the amount should be kept even lower.

In an embodiment of the invention, said polymer system comprises polymers having a molecular weight (Mn) from about 250000 to 500000 g/mol in an amount of less than 4% by weight of said polymer system.

In an embodiment of the invention, at least one of said at least partly biodegradable polymers has a molecular weight (Mn) in the range of about 1000 to 250000 g/mol, preferably 2000 to 50000 gμmol.

In an embodiment of the invention, at least one of said at least partly biodegradable polymers is a polyester polymer.

According to an embodiment of the invention, some of the most suitable biodegradable polymers for application in a toffee gum of the invention are polyesters.

In an embodiment of the invention, said at least partly biodegradable polymers comprise at least one polyester polymer obtainable by polymerization of at least one cyclic ester. These polyesters are preferred in an embodiment of the invention, because they may possess advantageous non-elastomeric properties.

In an embodiment of the invention, at least one of said at least one cyclic ester is selected from the group of monomers comprising glycolides, lactides, lactones, cyclic carbonates or mixtures thereof.

In an embodiment of the invention, at least one of said lactone monomers is selected from the group of ε-caprolactone, δ-valerolactone, γ-butyrolactone, and β-propiolactone, including ε-caprolactones, δ-valerolactones, γ-butyrolactones, or β-propiolactones that have been substituted with one or more alkyl or aryl substituents at any non-carbonyl carbon atoms along the ring, including compounds in which two substituents are contained on the same carbon atom.

In an embodiment of the invention, at least one of said carbonate monomers is selected from the group of trimethylene carbonate, 5-alkyl-1,3-dioxan-2-one, 5,5-dialkyl-1,3-dioxan-2-one, or 5-alkyl-5-alkyloxycarbonyl-1,3-dioxan-2-one, ethylene carbonate, 3-ethyl-3-hydroxymethyl, propylene carbonate, trimethylolpropane monocarbonate, 4,6-dimethyl-1,3-propylene carbonate, 2,2-dimethyl trimethylene carbonate, and 1,3-dioxepan-2-one and mixtures thereof.

In an embodiment of the invention, said at least one polyester polymer obtainable by polymerization of at least one cyclic ester is selected from the group consisting of poly (L-lactide), poly (D-lactide), poly (D, L-lactide), poly (mesolactide), poly (glycolide), poly (trimethylenecarbonate), poly (epsilon-caprolactone), poly (L-lactide-co-D, L-lactide), poly (L-lactide-co-meso-lactide), poly (L-lactide-co-glycolide), poly (L-lactide-co-trimethylenecarbonate), poly (L-lactide-co-epsilon-caprolactone), poly (D, L-lactide-co-meso-lactide), poly (D, L-lactide-co-glycolide), poly (D, L-lactide-co-trimethylenecarbonate), poly (D, L-lactide-co-epsilon-caprolactone), poly (meso-lactide-co-glycolide), poly (meso-lactide-co-trimethylenecarbonate), poly (meso-lactide-co-epsilon-caprolactone), poly (glycolide-cotrimethylenecarbonate), poly (glycolide-co-epsilon-caprolactone), or any combination thereof.

In an embodiment of the invention, said at least partly biodegradable polymers comprise at least one polyester polymer obtainable by condensation polymerization of at least one polyfunctional alcohol or derivative thereof and at least one polyfunctional acid or derivative thereof.

According to an embodiment of the invention, some or even all of the polymers in the polymer system may be biodegradable, and in a preferred embodiment the applied biodegradable polymers are polyesters.

According to an embodiment of the invention, polyesters obtained by ring-opening polymerization of cyclic esters may be applied as resinous polymers in the toffee gum, and polyesters obtained by polycondensation may in an embodiment of the invention be applied as elastomers. However, polyesters obtained by polycondensation may also be provided with substantially non-elastomeric properties and thus be applicable in large amounts in the polymer system.

In other words, according to an embodiment of the invention, polyesters obtained by polycondensation may provide the non-elastomeric properties or contribute thereto.

In an embodiment of the invention, said at least one polyfunctional acid is selected from the group consisting of oxalic acid, malonic acid, citric acid, succinic acid, malic acid, tartaric acid, fumaric acid, maleic acid, glutaric acid, glutamic acid, adipic acid, glucaric acid, pimelic acid, suberic acid, azelaic acid, sebacic acid, dodecanedioic acid, cyclopropane dicarboxylic acid, cyclobutane dicarboxylic acid, cyclohexane dicarboxylic acid, terephthalic acid, isophthalic acid, phthalic acid, trimellitic acid, pyromellitic acid, naphthalene 1,4-dicarboxylic acid, naphthalene 2,3-dicarboxylic acid, naphthalene 2,6-dicarboxylic acid, or any combination thereof.

In an embodiment of the invention, said at least one polyfunctional alcohol is selected from the group consisting of ethylene glycol, 1,2-propanediol, 1,3-propanediol, 1,3-butanediol, 1,4-butanediol, 1,6-hexanediol, diethylene glycol, 1,4-cyclohexanediol, 1,4-cyclohexanedimethanol, neopentyl glycol, glycerol, trimethylolpropane, pentaerythritol, sorbitol, mannitol, or any combination thereof.

According to an embodiment of the invention, said derivative of said at least one polyfunctional acid may be selected from the group of hydroxy carboxylic acids, and esters, anhydrides or halides of carboxylic acids. Likewise, said derivative of said at least one polyfunctional alcohol may be an ester of an alcohol

In an embodiment of the invention, said polyester is obtainable through reaction of at least one acid or derivative thereof selected from the group of terephthalic, phthalic, adipic, pimelic, succinic, malonic acids with at least one alcohol or derivative thereof selected from the groups of methylene, ethylene, propylene, butylene diols.

In an embodiment of the invention, said at least partly biodegradable polymers constitute at least 80%, preferably at least 90%, and most preferably about 100% by weight of said polymer system.

According to a preferred embodiment of the invention, the toffee gum is substantially free of conventional polymers such as natural and synthetic elastomers and resins, which are typically applied within the art of manufacturing conventional substantially non-degradable chewing gum.

In an embodiment of the invention, at least 70%, preferably at least 90% by weight of said at least partly biodegradable polymers have molecular weights (Mn) in the range of 2000 to 100000 g/mol.

In an embodiment of the invention, at least 70%, preferably at least 90% by weight of said at least partly biodegradable polymers have glass transition temperatures (T_{g}) in the range of 0 to 60° C., preferably 10 to 50° C.

In an embodiment of the invention, at the most 30%, preferably at the most 10% by weight of said at least partly biodegradable polymers have molecular weights (Mn) in the range of 100000 to 500000 g/mol.

In an embodiment of the invention, at the most 30%, preferably at the most 10% by weight of said at least partly biodegradable polymers have glass transition temperatures (T_{g}) in the range of −1 to −100° C., preferably −10 to −80° C.

According to an embodiment of the invention, a biodegradable polymer having glass transition temperature (T_{g}) in the range of 0 to 60° C. may have substantially non-elastomeric properties, while a biodegradable polymer having glass transition temperature (T_{g}) in the range of −1 to −100° C. may comprise more elastomeric properties.

According to a further embodiment of the invention the polymer system of the toffee gum comprises at least 70% of biodegradable polymers having molecular weights (Mn) in the range of 2000 to 100000 g/mol and glass transition temperatures (Tg) in the range of 0 to 60° C.

According to a further embodiment of the invention the polymer system of the toffee gum comprises at least 95% of biodegradable polymers having molecular weights (Mn) in the range of 2000 to 100000 g/mol and glass transition temperatures (Tg) in the range of 0 to 60° C.

According to a further preferred embodiment of the invention the polymer system of the toffee gum substantially consists of biodegradable polymers having molecular weights (Mn) in the range of 2000 to 100000 g/mol and glass transition temperatures (T_{g}) in the range of 0 to 60° C.

In an embodiment of the invention, at least one of said at least partly biodegradable polymers is non-elastomeric.

According to the invention, it has been found that it is a key feature of the toffee gum that it comprises a polymer system of which the main part is composed of substantially non-elastomeric biodegradable polymers.

In an embodiment of the invention, at least one of said at least partly biodegradable non-elastomeric polymers has a molecular weight in the range of 2000 to 200000 gμmol, preferably 4000 to 100000 g/mol, and most preferably 5000 to 50000 g/mol.

According to an embodiment of the invention, biodegradable polymers, e.g. polyesters having different molecular weights (Mn) within the range of 2000 to 50000 g/mol may show very desirable rather non-elastomeric properties and may be very important for obtaining the toffee-like consistency of the toffee gum.

In an embodiment of the invention, at least one of said at least partly biodegradable non-elastomeric polymers has a glass transition temperature (T_{g}) in the range of −10 to 100° C., preferably 0 to 60° C., more preferably 10 to 50° C., and most preferably 20 to 40° C.

According to a preferred embodiment of the invention, the polymer system may show at least one T_{g} within the range of 0 to 60° C., resulting from at least partly biodegradable non-elastomeric polymers. The most preferred T_{g} of the final toffee gum may, according to an embodiment of the invention, lie within the range of 20 to 40° C.

In an embodiment of the invention, said at least partly biodegradable non-elastomeric polymers constitute in the range of 70% to 100%, preferably 80% to 100%, and most preferably 90% to 100% by weight of said polymer system.

According to the invention, a toffee-like texture of the toffee gum confectionery product may be obtained, when the polymer system is comprised mostly of non-elastomeric biodegradable polymers.

According to a preferred embodiment of the invention, it has been found that the desired toffee-like properties of the toffee gum confectionery product may be obtained when applying 70 to 100 weight percent of non-elastomeric biodegradable polymers in the polymer system of the toffee gum. The polymers herein referred to as non-elastomeric, may according to an embodiment of the invention also be characterized as resinous.

Such properties of the main part of the polymers are essential in order to obtain the desired consistency. Application of elastomers (elastomeric polymers) in too large amounts have been found to spoil the desired consistency—and make the product texture more chewing gum-like, which is far from the desired toffee-like consistency.

In an embodiment of the invention, at least one of said at least partly biodegradable polymers is elastomeric.

Only a small amount of elastomeric biodegradable polymers may be applied, without spoiling the desired texture of the toffee gum. They may be used for adjusting the texture, and may contribute with more robustness, but preferably elastomers are avoided.

In an embodiment of the invention, at least one of said at least partly biodegradable elastomeric polymers has a molecular weight in the range of 10000 to 250000 g/mol, preferably 15000 to 100000 g/mol, and most preferably 20000 to 50000 g/mol.

In an embodiment of the invention, at least one of said at least partly biodegradable elastomeric polymers has a glass transition temperature (T_{g}) in the range of −1 to −100° C., preferably −10 to −80° C.

In an embodiment of the invention, said at least partly biodegradable elastomeric polymers constitute in the range of 0% to 30%, preferably 0% to 20%, and most preferably 0% to 10% by weight of said polymer system.

Although, a small amount of elastomeric polymer may contribute to adjust the toffee-like texture, it is crucial for obtaining the desired toffee texture that the amount of elastomeric polymer is kept relatively low. Otherwise, the toffee gum is in danger of acquiring more chewing gum-like textural properties, which are undesired in the toffee gum of the invention.

In an embodiment of the invention, said toffee gum comprises at least one softener in an amount in the range of 0.5% to 25%, preferably in the range of 1% to 18%, and most preferably in the range of 2% to 12% by weight of said toffee gum.

Softeners may be mixed with the polymers in order to soften the polymer system. The softened polymer system may be mixed with sweeteners, flavors, and etc., whereby a toffee gum according to the invention may be prepared.

As referred to herein, the term “softener” covers both softening compounds and compounds, which may be regarded as plasticizers.

In an embodiment of the invention, at least a part of said softener is incorporated in the polymer system, e.g. by mechanical mixing prior to the mixing of the polymer system with the further ingredients of the toffee gum. A mechanical mixing process may e.g. comprise extrusion or batch mixing processes such as those applied within the field of chewing gum.

In an embodiment of the invention, said at least one softener is selected from the group consisting of triacetin, lecithin, acetylated glycerides, mono- and di-glycerides, or any combination thereof.

According to an embodiment of the invention, the preferred softeners are mono- or di-glycerides. It has been found that these softeners are mild in the sense that they are not inclined to affect the texture of the toffee gum to an undesirable high extent. Thus, mono- or diglycerides are ideal as softeners for adjusting and fine-tuning of the toffee-like texture of the toffee gum confectionery product. The mild features of mono- or di-glycerides are of importance and especially appreciated because of the biodegradability of the applied polymers according to the invention. This is owing to the observation that more vulnerability may be experienced, when processing the biodegradable polymers as compared to more conventional polymers.

Furthermore, according to an embodiment of the invention, it has been observed that mild softeners, such as mono- or di-glycerides may be applied and exerting a softening effect, without affecting the glass transition temperature of the polymer system and toffee gum.

In an embodiment of the invention, said toffee gum comprises at least one syrup of a polyol in an amount of 1% to 25%, preferably 5% to 20% by weight of said toffee gum.

In an embodiment of the invention, the desired toffee-like texture may be obtained, when a considerable amount of polyol syrup is added to the toffee gum.

According to an embodiment of the invention, a polymer system mostly composed of non-elastomeric biodegradable polymers and a quite large amount of polyol syrup in the final toffee gum may contribute to provide the toffee gum with very desirable textural properties according to the invention.

According to an embodiment of the invention, an advantageous syrup of a polyol, for application in the toffee gum, is maltitol syrup. According to an embodiment of the invention, maltitol syrup is a preferred choice as the polyol syrup for regulating the texture of the toffee gum and for softening the substantially non-elastomeric biodegradable polymer.

According to an embodiment of the invention, a polyol syrup such as maltitol syrup may advantageously be applied in the toffee gum as a mildly softening compound, which is also conferring a nice sweet taste to the product.

According to an embodiment of the invention, application of a polyol syrup such as maltitol syrup in an amount in the range of 5 to 25 weight percent of the product may contribute significantly in obtaining the desired toffee-like consistency of the toffee gum.

In an embodiment of the invention, the toffee gum comprises less than 6%, preferably less than 4% by weight of filler, preferably less than 1% by weight.

In an embodiment of the invention, the toffee gum is substantially free of filler.

In an embodiment of the invention, said toffee gum comprises at said least one flavor in an amount of about 0.001% to 30% by weight, and said at least one sweetener in an amount of about 5% to 80% by weight.

Flavors, sweeteners and further ingredients may be selected from those mentioned in the detailed description of the present invention.

In an embodiment of the invention, said at least one flavor is substantially oil-based and/or substantially hydrophilic flavors.

In an embodiment of the invention, said at least one sweetener is a sugar.

In an embodiment of the invention, said at least one sweetener is an artificial sweetener.

In an embodiment of the invention said artificial sweetener is selected from the group consisting of sorbitol, mannitol, maltitol, xylitol, erythritol, lactitol, isomalt, derivatives of isomalt, or any combination thereof.

In an embodiment of the invention said artificial sweetener is a high-intensity artificial sweetener selected from the group consisting of aspartame, salts of acesulfame, alitame, neotame, twinsweet, saccharin and its salts, cyclamic acid and its salts, glycyrrhizin, dihydrochalcones, thaumatin, monellin, stevioside, sucralose, or any combination thereof.

In an embodiment of the invention, said toffee gum further comprises active ingredients.

According to an embodiment of the invention, applicable active ingredients may be selected among those listed in the detailed description.

In an embodiment of the invention, said toffee gum forms a tablet comprising a chewable polymer system.

In an embodiment of the invention, said toffee gum is formed in shapes such as cores, ellipsoid, balls, cylinders, squares, rectangular, hexagonal, strips, paraboloid, donut formed, ring formed, teddy bear formed and/or multi-modular.

In an embodiment of the invention, said toffee gum weighs from about ¼ gram to about 10 grams.

In an embodiment of the invention, said toffee gum weighs from about ½ gram to about 5 grams.

In an embodiment of the invention, said toffee gum is provided with an outer coating.

In an embodiment of the invention, said coating is selected from the group consisting of hard coating, soft coating and edible film coating.

In an embodiment of the invention, said coating comprises chocolate.

In an embodiment of the invention, said toffee gum is center-filled.

In an embodiment of the invention, said toffee gum is compressed.

According to an embodiment of the invention, it may be advantageous to apply compression techniques in the manufacture of the toffee gum. E.g. when incorporating ingredients being vulnerable to elevated temperatures or mixing processes, it may be preferable to apply compression in the preparation of the toffee gum of the present invention.

The present invention furthermore relates to a method of manufacturing a toffee gum according to any of the claims 1-60, whereby the product is manufactured by a batch process.

Moreover, the present invention relates to a method of manufacturing a toffee gum according to any of the claims 1-60, whereby the product is manufactured by an extruder process.

### DETAILED DESCRIPTION

According to a preferred definition of biodegradability according to the invention, biodegradability is a property of certain organic molecules whereby, when exposed to the natural environment or placed within a living organism, they react through an enzymatic or microbial process, often in combination with a chemical process such as hydrolysis, to form simpler compounds, and ultimately carbon dioxide, nitrogen oxides, methane, water and the like.

In the present context the term ‘biodegradable polymers’ means environmentally or biologically degradable polymer compounds which, after dumping the toffee gum confectionery product, are capable of undergoing a physical, chemical and/or biological degradation, whereby the dumped toffee gum waste becomes more readily removable from the site of dumping or is eventually disintegrated to lumps or particles, which are no longer recognizable as being remnants from the toffee gum. The degradation or disintegration of such degradable polymers may be effected or induced by physical factors such as temperature, light, moisture, etc., by chemical factors such as oxidative conditions, pH, hydrolysis, etc. or by biological factors such as microorganisms and/or enzymes. The degradation products may be larger oligomers, trimers, dimers and monomers.

Preferably, the ultimate degradation products are small inorganic compounds such as carbon dioxide, nitrogen oxides, methane, ammonia, water, etc.

As referred to herein, the glass transition temperature (Tg) may be determined by for example DSC (DSC: differential scanning calorimetry). The DSC may generally be applied for determining and studying of the thermal transitions of a polymer and specifically, the technique may be applied for the determination of a second order transition of a material. The transition at Tg is regarded as such a second order transition, i.e. a thermal transition that involves a change in heat capacity, but does not have a latent heat. Hence, DSC may be applied for studying Tg.

Unless otherwise indicated, as used herein with regard to polymers, the term “molecular weight” means number average molecular weight (Mn) in g/mol. Furthermore, as used herein the short form PD designates the polydispersity of polymers, polydispersity being defined as Mw/Mn, where Mw is the weight average molecular weight of a polymer. A well-established technique for characterization of biodegradable polymers is gel permeation chromatography (GPC).

A toffee gum confectionery product according to the present invention may typically comprise a polymer system and additional ingredients comprising flavoring agents, sweetening agents, texture-modifying agents and further optional ingredients. Most part of the additional ingredients may typically be water-soluble ingredients. However, lipo-soluble ingredients may be fully applicable, such as for example flavoring oils.

The polymer system may include one or more polymers and may be mixed with a softening agent. The polymers are retained in the mouth and not swallowed during use, which has the advantageous effect of prolonging the toffee-like experience compared to conventional toffee products, which are normally completely swallowed.

Softening agents may be mixed into the polymers before addition of further ingredients, or mixed into the toffee gum composition at any time during the mixing procedure. In an embodiment of the invention, a part of the softening agents are added early in the process, e.g. added to the polymers alone, and further parts of the softening agents are added later on in the mixing process of the toffee gum.

Different kinds of softening agents may be useful for adjusting the texture of a specific polymer system. The exact composition of the polymer system and specific choice of additional ingredients, including softening, flavoring and sweetening agents, define the release properties of the toffee gum. The release rate of flavor and sweetener may be adjusted to be higher or lower during different phases of a chewing- and consuming-period of the toffee gum.

By addition of flavoring and sweetening agents into the toffee gum, any desired taste may be obtained, such as for example liquorice, chocolate, toffee, fruit, etc.

Examples are given in the following of applicable components in the polymer system and of additional ingredients in toffee gum products according to the invention.

The polymer system may comprise biodegradable polymers in an amount of 70% to 100% by weight of the polymer system. The polymer system may comprise resinous polymers and minor amounts of elastomeric polymers. Softening agents may further be incorporated into the polymer system.

The polymer system may furthermore be mixed with fillers, waxes and fats. However, these components are not preferred according to the invention, as they are generally not contributing to the desired toffee-like texture properties.

The polymer system may typically comprise polymer components in amounts in the following ranges (by weight of the polymer system): 0% to 30% elastomeric polymers and 70% to 100% biodegradable polymers of molecular weight (Mn) in the range of 1000 to 250000 g/mol, preferably 2000 to 100000 g/mol.

According to the invention, the applied biodegradable polymers of molecular weight (Mn) in the range of 1000 to 250000 g/mol may preferably be characterized by resinous properties.

Furthermore, softening agents may be added in an amount of 0% to 30% by weight in relation to the polymer system. Mild softening ingredients of the toffee gum such as polyol syrup, e.g. maltitol syrup, may within a normal range be added to the toffee gum in an amount of about 0% to 25% by weight of the toffee gum.

The polymer system may constitute about 5% to about 95% by weight of the toffee gum confectionery product, more typically in the range of about 20% to about 75% by weight of the toffee gum.

Elastomers may provide rubbery, cohesive features to the toffee gum, and the effect of an elastomer varies depending on its chemical structure and how it may be compounded with other ingredients. Elastomers suitable for use in the polymer system and toffee gum according to the invention may include natural, synthetic and/or biodegradable types. The amount of elastomer should according to preferred embodiments of the invention be kept rather low with respect to the remainder polymers of the polymer system, and the elastomers may preferably be omitted. This is due to the rubbery characteristics, which may be undesired or only desired to a little extent in toffee gum products according to the invention.

The elastomer compounds may be of natural origin but are preferably of synthetic origin, preferably biodegradable polymers, e.g. polyesters. The molecular weight (Mn) of the elastomers may range from 10000 to 500000 g/mol, preferably from 15000 to 250000 g/mol, and most typically from 20000 to 100000 g/mol.

According to the present invention, the biodegradable polymers, e.g. polyesters, characterized as resinous, resin-like polymers may preferably have molecular weights (Mn) within the range of 1000 to 250000 g/mol, preferably 2000 to 200000 g/mol, and more preferably 4000 to 100000 g/mol. The resinous polymers may vary the firmness of the polymer system and toffee gum. Different biodegradable resinous polymers may be combined in the polymer system, and by their individual properties, e.g. softening points, the firmness, softness and further textural properties of the toffee gum may be varied.

Biodegradable resinous polymers of molecular weights (Mn) in the range of 1000 to 250000 g/mol, preferably 2000 to 200000 g/mol, and more preferably 4000 to 100000 g/mol applied according to the invention may also be referred to as resin compounds or synthetic resins and may e.g. be polyesters.

In an embodiment of the invention, the biodegradable polymers having resinous properties may be referred to as non-elastomeric.

Suitable examples of environmentally or biologically degradable polymers, which may be applicable in the polymer system and toffee gum according to the invention, include degradable polyesters, poly(ester-carbonates), polycarbonates, polyester amides, polypeptides, polyurethane, polyhydroxyalknoates, homopolymers of amino acids such as polylysine, and proteins including derivatives thereof such as e.g. protein hydrolysates including a zein hydrolysate.

Generally, the biodegradable polymers used in the toffee gum of the present invention may be homopolymers, copolymers or terpolymers, including graft- and block-polymers.

According to an embodiment of the invention, particularly useful biodegradable polymers include polyester polymers obtained by the polymerization of one or more cyclic esters such as lactide, glycolide, trimethylene carbonate, δ-valerolactone, β-propiolactone and ε-caprolactone, and polyesters obtained by condensation polymerization of a mixture of open-chain polyacids and polyols, for instance, adipic acid and di(ethylene glycol). Hydroxy carboxylic acids such as 6-hydroxycaproic acid may also be used to form polyesters or they may be used in conjunction with mixtures of polyacids and polyols.

In an embodiment of the invention, some preferred biodegradable polyester compounds may be produced from cyclic esters and may be obtained by ring-opening polymerization of one or more cyclic esters, such as glycolides, lactides, lactones and carbonates. The polymerization process to obtain such advantageously degradable polyesters may take place in the presence of at least one appropriate catalyst such as metal catalysts, of which stannous octoate is a non-limiting example and the polymerization process may be initiated by initiators such as polyols, polyamines or other molecules with multiple hydroxyl or other reactive groups and mixtures thereof.

Accordingly, the biodegradable polyesters produced by condensation polymerization through reaction of at least one alcohol or derivative thereof and at least one acid or derivative thereof may also be suitable polymers in the polymer system of the toffee gum according to the invention. These polycondensation polyesters may generally be prepared by step-growth polymerization of di-, tri- or higher-functional alcohols or esters thereof with di-, tri- or higher-functional aliphatic or aromatic carboxylic acids or esters thereof. Likewise, also hydroxy acids or anhydrides and halides of polyfunctional carboxylic acids may be used as monomers. The polymerization may involve direct polyesterification or transesterification and may be catalyzed. Use of branched monomers suppresses the crystallinity of the polyester polymers. Mixing of dissimilar monomer units along the chain also suppresses crystallinity. To control the reaction and the molecular weight of the resulting polymer the polymer chains may be ended by addition of monofunctional alcohols or acids and/or to utilize a stoichiometric imbalance between acid groups and alcohol groups or derivatives of either. Also the adding of long chain aliphatic carboxylic acids or aromatic monocarboxylic acids may be used to control the degree of branching in the polymer and conversely multifunctional monomers are sometimes used to create branching.

Moreover, following the polymerization monofunctional compounds may be used to endcap the free hydroxyl and carboxyl groups.

Furthermore, polyfunctional carboxylic acids are in general high-melting solids that have very limited solubility in the polycondensation reaction medium. Often esters or anhydrides of the polyfunctional carboxylic acids are used to overcome this limitation. Polycondensations involving carboxylic acids or anhydrides produce water as the condensate, which requires high temperatures to be driven off. Thus, polycondensations involving transesterification of the ester of a polyfunctional acid are often the preferred polymerization process. For example, the dimethyl ester of terephthalic acid may be used instead of terephthalic acid itself. In this case, methanol rather than water is condensed, and the former can be driven off more easily than water. Usually, the reaction is carried out in the bulk (no solvent) and high temperatures and vacuum are used to remove the by-product and drive the reaction to completion. In addition to an ester or anhydride, a halide of the carboxylic acid may also be used under certain circumstances.

Additionally for preparation of polyesters of this polycondensation-type, the preferred polyfunctional carboxylic acids or derivatives thereof are usually either saturated or unsaturated aliphatic or aromatic and contain 2 to 100 carbon atoms and more preferably 4 to 18 carbon atoms. In the polymerization of this type of polyester some applicable examples of carboxylic acids, which may be employed as such or as derivatives thereof, includes aliphatic polyfunctional carboxylic acids such as oxalic, malonic, citric, succinic, malic, tartaric, fumaric, maleic, glutaric, glutamic, adipic, glucaric, pimelic, suberic, azelaic, sebacic, dodecanedioic acid, etc. and cyclic aliphatic polyfunctional carboxylic acids such as cyclopropane dicarboxylic acid, cyclobutane dicarboxylic acid, cyclohexane dicarboxylic acid, etc. and aromatic polyfunctional carboxylic acids such as terephthalic, isophthalic, phthalic, trimellitic, pyromellitic and naphthalene 1,4-, 2,3-, 2,6-dicarboxylic acids and the like. For the purpose of illustration and not limitation, some examples of carboxylic acid derivatives include hydroxy acids such as 3-hydroxy propionic acid and 6-hydroxycaproic acid and anhydrides, halides or esters of acids, for example dimethyl or diethyl esters, corresponding to the already mentioned acids, which means esters such as dimethyl or diethyl oxalate, malonate, succinate, fumarate, maleate, glutarate, adipate, pimelate, suberate, azelate, sebacate, dodecanedioate, terephthalate, isophthalate, phthalate, etc. Generally speaking, methyl esters are sometimes more preferred than ethyl esters due to the fact that higher boiling alcohols are more difficult to remove than lower boiling alcohols.

Furthermore, the usually preferred polyfunctional alcohols, for preparation of the polycondensation-type polyesters, contain 2 to 100 carbon atoms as for instance polyglycols and polyglycerols. In the polymerization process of this type of polyester some applicable examples of alcohols, which may be employed as such or as derivatives thereof, includes polyols such as ethylene glycol, 1,2-propanediol, 1,3-propanediol, 1,3-butanediol, 1,4-butanediol, 1,6-hexanediol, diethylene glycol, 1,4-cyclohexanediol, 1,4-cyclohexanedimethanol, neopentyl glycol, glycerol, trimethylolpropane, pentaerythritol, sorbitol, mannitol, etc. For the purpose of illustration and not limitation, some examples of alcohol derivatives include triacetin, glycerol palmitate, glycerol sebacate, glycerol adipate, tripropionin, etc.

Additionally, with regard to polymerization of polycondensation-type polyesters, the chain-stoppers sometimes used are monofunctional compounds. They may preferably either be monohydroxy alcohols containing 1-20 carbon atoms or monocarboxylic acids containing 2-26 carbon atoms. General examples are medium or long-chain fatty alcohols or acids, and specific examples include monohydroxy alcohols such as methanol, ethanol, butanol, hexanol, octanol, etc. and lauryl alcohol, myristyl alcohol, cetyl alcohol, stearyl alcohol, stearic alcohol, etc. and monocarboxylic acids such as acetic, lauric, myristic, palmitic, stearic, arachidic, cerotic, dodecylenic, palmitoleic, oleic, linoleic, linolenic, erucic, benzoic, naphthoic acids and substituted napthoic acids, 1-methyl-2 naphthoic acid and 2-isopropyl-1-naphthoic acid, etc.

Moreover, an acid catalyst or a transesterification catalyst is typically used in the polymerization of polyesters by polycondensation, and non-limiting examples of those are the metal catalysts such as acetates of manganese, zinc, calcium, cobalt or magnesium, and antimony(III)oxide, germanium oxide or halide and tetraalkoxygermanium, titanium alkoxide, zinc or aluminum salts.

In accordance with the general principles in manufacturing a toffee gum product within the scope of the invention, variations of different suitable ingredients are listed and explained below.

Colorants, whiteners and antioxidants are optional ingredients, which may be mixed with the polymer system and may comprise an amount of up to about 5% by weight of the polymer system. The antioxidants may e.g. be chosen among butylated hydroxytoluene (BHT), butyl hydroxyanisol (BHA), propylgallate and tocopherols, and preservatives. The coloring agents and whiteners may for example comprise FD&C-type dyes and lakes, fruit or vegetable extracts, titanium dioxide, and combinations thereof.

In an embodiment of the invention, the toffee gum may comprise one or more softening agents in an amount of about 0 to about 18% by weight of the toffee gum, more typically about 0 to about 12% by weight of the toffee gum.

The softeners as well as emulsifiers may according to an embodiment of the invention be added both during mixing of the polymer system and later during mixing of the final toffee gum.

The softening ingredient may soften the polymer system and toffee gum formulation and may contribute to encompass ingredients such as waxes, fats, oils, emulsifiers, surfactants and solubilisers, which may optionally be added.

The softening agents e.g. sucrose esters may include those disclosed in WO 00/25598, which is incorporated herein by reference. Softening agents may further include tallow, hydrogenated tallow, hydrogenated and partially hydrogenated vegetable oils, cocoa butter, degreased cocoa powder, glycerol monostearate, glyceryl triacetate, lecithin, mono-, di- and triglycerides, acetylated monoglycerides, fatty acids (e.g. stearic, palmitic, oleic and linoleic acids) and combinations thereof. According to an embodiment of the invention, the preferred softener applied in the toffee gum may be triacetin.

Addition of one or more emulsifiers, which are also supplying softness to the product, may furthermore contribute to providing the product with water-binding properties and a pleasant smooth surface, and to reduce potential adhesive properties of the product. In an embodiment of the invention, the emulsifiers may comprise 0 to 18% by weight, preferably 0 to 12% by weight of the polymer system. Examples of emulsifiers may include mono- and diglycerides of edible fatty acids, lactic acid esters and acetic acid esters of mono- and diglycerides of edible fatty acids, acetylated mono and diglycerides, sugar esters of edible fatty acids, Na—, K—, Mg— and Ca-stearates, lecithin, hydroxylated lecithin and the like.

In case of the presence of biologically or pharmaceutically active ingredients as defined below, certain specific emulsifiers and/or solubilisers may be added in the toffee gum formulation in order to disperse and release these ingredients.

According to a preferred embodiment of the invention, the glass transition temperature(s) of the polymer system may be in the range of 0 to 50° C., preferably within the range of 20 to 40° C. The preferred T_{g} may be experienced by the polymer system alone or combined with one or more softeners, such as those mentioned above.

In an embodiment of the invention, waxes and fats may in be used in a very limited amount for adjustment of consistency and for softening of the toffee gum confectionery product. In connection with the present invention, examples of waxes and fats include for instance rice bran wax, polyethylene wax, petroleum wax (refined paraffin and microcrystalline wax), paraffin, beeswax, carnauba wax, candelilla wax, cocoa butter, degreased cocoa powder and any suitable oil or fat, as e.g. completely or partially hydrogenated vegetable oils or completely or partially hydrogenated animal fats.

As waxes are generally not biodegradable, they are typically not preferred in the toffee gum of the present invention. Fats are also not preferred in any substantial amount in the toffee gum of the present invention, as they have a tendency to counteract the desired toffee-like texture of the product. If waxes and/or fats are added, anyway, the amount should be within the range of 0% to 30% by weight in relation to the polymer system. Keeping the amount of fat low in the toffee gum composition may have the advantageous effect that the toffee gum may be more robust for a soft coating, e.g. a coating with chocolate.

In an embodiment of the invention, the toffee gum may comprise filler in a small amount of about 0% to 10%, preferably 0% to 5% by weight of the toffee gum. However, within the range, the result of increasing the amount of filler may be that the final texture and consistence of the toffee gum may be tackier and lack more coherence. Examples of fillers and/or texturisers include magnesium and calcium carbonate, sodium sulphate, ground limestone, silicate compounds such as magnesium and aluminum silicate, kaolin and clay, aluminum oxide, silicium oxide, talc, titanium oxide, mono-, di- and tri-calcium phosphates, cellulose polymers, such as wood, and combinations thereof.

Typically, the most preferred texture according to the present invention may be obtained while avoiding fillers in the toffee gum composition.

Additional ingredients, which may be added to the toffee gum composition, are flavoring agents, bulk sweeteners, high-intensity sweeteners, acidulants, and other components that provide the desired attributes.

Suitable bulk sweeteners include both sugar and non-sugar sweetening components. Bulk sweeteners typically constitute from about 5% to about 95% by weight of the toffee gum, more typically about 20% to about 80% by weight such as 30% to 60% by weight of the toffee gum.

Useful sugar sweeteners are saccharide-containing components including, but not limited to, sucrose, dextrose, maltose, dextrins, trehalose, D-tagatose, dried invert sugar, fructose, levulose, galactose, corn syrup solids, and the like, alone or in combination.

Sorbitol can be used as a non-sugar sweetener. Other useful non-sugar sweeteners include, but are not limited to, other sugar alcohols such as mannitol, xylitol, hydrogenated starch hydrolysates, maltitol, isomaltol, erythritol, lactitol and the like, alone or in combination.

High-intensity artificial sweetening agents can also be used alone or in combination with the above sweeteners. Preferred high-intensity sweeteners include, but are not limited to sucralose, aspartame, salts of acesulfame, alitame, neotame, twinsweet, saccharin and its salts, cyclamic acid and its salts, glycyrrhizin, dihydrochalcones, thaumatin, monellin, stevioside and the like, alone or in combination.

In order to provide longer lasting sweetness and flavor perception, it may be desirable to encapsulate or otherwise control the release of at least a portion of the artificial sweetener. Techniques such as wet granulation, wax granulation, spray drying, spray chilling, fluid bed coating, coascervation, encapsulation in yeast cells and fiber extrusion may be used to achieve the desired release characteristics. Encapsulation of sweetening agents can also be provided using another component, which is already generally applied in the toffee gum such as a resinous compound.

Usage level of the high-intensity artificial sweetener will vary considerably and will depend on factors such as potency of the sweetener, rate of release, desired sweetness of the product, level and type of flavor used and cost considerations. Thus, the active level of high-potency artificial sweetener may vary from about 0% to about 8% by weight, preferably 0.001% to about 5% by weight. When carriers used for encapsulation are included, the usage level of the encapsulated sweetener will be proportionately higher.

Combinations of sugar and/or non-sugar sweeteners can be used in the toffee gum formulation processed in accordance with the invention. Additionally, the softener may also provide additional sweetness such as aqueous sugar or alditol solutions.

If a low-calorie product is desired, a low-caloric bulking agent may be used. Examples of low-caloric bulking agents include polydextrose, Raftilose, Raftilin, fructooligosaccharides (NutraFlora®), palatinose oligosaccharides; guar gum hydrolysates (e.g. Sun Fiber®) or indigestible dextrins (e.g. Fibersol®). However, other low-caloric bulking agents may be used.

The toffee gum according to the present invention may contain aroma agents and flavoring agents including natural and synthetic flavorings e.g. in the form of natural vegetable components, essential oils, essences, extracts, powders, including acids and other substances capable of affecting the taste profile. Examples of liquid and powdered flavorings include coconut, coffee, chocolate, vanilla, grape fruit, orange, lime, menthol, liquorice, caramel aroma, honey aroma, peanut, walnut, cashew, hazelnut, almonds, pineapple, strawberry, raspberry, tropical fruits, cherries, cinnamon, peppermint, wintergreen, spearmint, eucalyptus, and mint, fruit essence such as from apple, pear, peach, strawberry, apricot, raspberry, cherry, pineapple, and plum essence. The essential oils include peppermint, spearmint, menthol, eucalyptus, clove oil, bay oil, anise, thyme, cedar leaf oil, nutmeg, and oils of the fruits mentioned above.

The toffee gum flavor may be a natural flavoring agent, which is freeze-dried, preferably in the form of a powder, slices or pieces or combinations thereof. The particle size may be less than 3 mm, less than 2 mm or more preferred less than 1 mm, calculated as the longest dimension of the particle. The natural flavoring agent may be in a form, where the particle size is from about 3 μm to 2 mm, such as from 4 μm to 1 mm. Preferred natural flavoring agents include seeds from fruit e.g. from strawberry, blackberry and raspberry.

Various synthetic flavors, such as mixed fruit flavors may also be used in the composition of the toffee gum according to the invention. As indicated above, the aroma agent may be used in quantities smaller than those conventionally used. The aroma agents and/or flavors may be used in the amount from 0.01% to about 30% by weight of the final product depending on the desired intensity of the aroma and/or flavor used. Preferably, the content of aroma/flavor is in the range of 0.2% to 3% by weight of the total composition.

In an embodiment of the invention, the flavoring agents comprise natural and synthetic flavorings in the form of natural vegetable components, essential oils, essences, extracts, powders, including acids and other substances capable of affecting the taste profile.

Further toffee gum ingredients, which may be included in the toffee gum according to the present invention, include surfactants and/or solubilisers, especially when pharmaceutically or biologically active ingredients are present. As examples of types of surfactants to be used as solubilisers in a toffee gum composition according to the invention, reference is made to H. P. Fiedler, Lexikon der Hilfstoffe für Pharmacie, Kosmetik und Angrenzende Gebiete, pages 63-64 (1981) and the lists of approved food emulsifiers of the individual countries. Anionic, cationic, amphoteric or non-ionic solubilisers can be used. Suitable solubilisers include lecithin, polyoxyethylene stearate, polyoxyethylene sorbitan fatty acid esters, fatty acid salts, mono and diacetyl tartaric acid esters of mono and diglycerides of edible fatty acids, citric acid esters of mono and diglycerides of edible fatty acids, saccharose esters of fatty acids, polyglycerol esters of fatty acids, polyglycerol esters of interesterified castor oil acid (E476), sodium stearoyllatylate, sodium lauryl sulfate and sorbitan esters of fatty acids and polyoxyethylated hydrogenated castor oil (e.g. the product sold under the trade name CREMOPHOR), block copolymers of ethylene oxide and propylene oxide (e.g. products sold under trade names PLURONIC and POLOXAMER), polyoxyethylene fatty alcohol ethers, polyoxyethylene sorbitan fatty acid esters, sorbitan esters of fatty acids and polyoxyethylene steraric acid esters.

Particularly suitable solubilisers are polyoxyethylene stearates, such as for instance polyoxyethylene(8)stearate and polyoxyethylene(40)stearate, the polyoxyethylene sorbitan fatty acid esters sold under the trade name TWEEN, for instance TWEEN 20 (monolaurate), TWEEN 80 (monooleate), TWEEN 40 (monopalmitate), TWEEN 60 (monostearate) or TWEEN 65 (tristearate), mono and diacetyl tartaric acid esters of mono and diglycerides of edible fatty acids, citric acid esters of mono and diglycerides of edible fatty acids, sodium stearoyllatylate, sodium laurylsulfate, polyoxyethylated hydrogenated castor oil, blockcopolymers of ethylene oxide and propyleneoxide and polyoxyethylene fatty alcohol ether. The solubiliser may either be a single compound or a combination of several compounds. In the presence of an active ingredient, the toffee gum may preferably also comprise a carrier known in the arts of chewing gum and pharmaceutical ingredients.

Emulsifiers, which are used as softeners may include tallow, hydrogenated tallow, hydrogenated and partially hydrogenated vegetable oils, cocoa butter, glycerol monostearate, glycerol triacetate, lechithin, mono-, di- and triglycerides, acetylated monoglycerides, fatty acids (e.g. stearic, palmitic, oleic and linoleic acids), and combinations thereof.

According to an embodiment of the invention, the toffee gum may comprise a pharmaceutically, cosmetically or biologically active substance. Examples of such active substances, a comprehensive list of which is found e.g. in WO 00/25598, which is incorporated herein by reference.

The active agents to be used in connection with the present invention may be any substance desired to be released from the toffee gum. If an accelerated rate of release is desired, corresponding to the effect obtained for the flavor, the primary substances are those with limited water solubility, typically below 10 g/100 ml including substances which are entirely water insoluble. Examples are medicines, dietary supplements, oral compositions, anti-smoking agents, highly potent sweeteners, pH adjusting agents, etc.

Further examples of active ingredients include paracetamol, benzocaine, cinnarizine, menthol, carvone, caffeine, chlorhexidine-di-acetate, cyclizine hydrochloride, 1,8-cineol, nandrolone, miconazole, mystatine, aspartame, sodium fluoride, nicotine, saccharin, cetylpyridinium chloride, other quaternary ammonium compounds, vitamin E, vitamin A, vitamin D, glibenclamide or derivatives thereof, progesterone, acetylsalicylic acid, dimenhydrinate, cyclizine, metronidazole, sodium hydrogen-carbonate, the active components from ginkgo, the active components from propolis, the active components from ginseng, methadone, oil of peppermint, salicylamide, hydrocortisone or astemizole.

Examples of active agents in the form of dietary supplements are for instance salts and compounds having the nutritive effect of vitamin B2 (riboflavin), B12, folinic acid, niacine, biotine, poorly soluble glycerophosphates, amino acids, the vitamins A, D, E and K, minerals in the form of salts, complexes and compounds containing calcium, phosphorus, magnesium, iron, zinc, copper, iodine, manganese, chromium, selenium, molybdenum, potassium, sodium or cobalt.

Furthermore, reference is made to lists of nutritients accepted by the authorities in different countries such as for instance US code of Federal Regulations, Title 21, Section 182.5013.182 5997 and 182.8013-182.8997.

Examples of active agents in the form of compounds for the care or treatment of the oral cavity and the teeth, are for instance bound hydrogen peroxide and compounds capable of releasing urea during chewing.

Examples of active agents in the form of antiseptics are for instance salts and compounds of guanidine and biguanidine (for instance chlorhexidine diacetate) and the following types of substances with limited water-solubility: quaternary ammonium compounds (for instance ceramine, chloroxylenol, crystal violet, chloramine), aldehydes (for instance paraformaldehyde), compounds of dequaline, polynoxyline, phenols (for instance thymol, para chlorophenol, cresol) hexachlorophene, salicylic anilide compounds, triclosan, halogenes (iodine, iodophores, chloroamine, dichlorocyanuric acid salts), alcools (3,4 dichlorobenzyl alcohol, benzyl alcohol, phenoxyethanol, phenylethanol), cf. furthermore Martindale, The Extra Pharmacopoeia, 28th edition, pages 547-578; metal salts, complexes and compounds with limited water-solubility, such as aluminum salts, (for instance aluminum potassium sulfate AIK (S04) 2, 12H20) and furthermore salts, complexes and compounds of boron, barium, strontium, iron, calcium, zinc, (zinc acetate, zinc chloride, zinc gluconate), copper (copper chloride, copper sulfate), lead, silver, magnesium, sodium, potassium, lithium, molybdenum, vanadium should be included; other compositions for the care of mouth and teeth: for instance; salts, complexes and compounds containing fluorine (such as sodium fluoride, sodiummonofluorophosphate, aminofluorides, stannous fluoride), phosphates, carbonates and selenium.

Cf. furthermore J. Dent. Res. Vol. 28 No. 2, pages 160-171, 1949, wherein a wide range of tested compounds are mentioned.

Examples of active agents in the form of agents adjusting the pH in the oral cavity include for instance: acceptable acids, such as adipinic acid, succinic acid, fumaric acid, or salts thereof or salts of citric acid, tartaric acid, malic acid, acetic acid, lactic acid, phosphoric acid and glutaric acid and acceptable bases, such as carbonates, hydrogen carbonates, phosphates, sulfates or oxides of sodium, potassium, ammonium, magnesium or calcium, especially magnesium and calcium.

Examples of active agents in the form of anti-smoking agents include for instance: nicotine, tobacco powder or silver salts, for instance silver acetate, silver carbonate and silver nitrate.

Further examples of active agents are medicines of any type.

Examples of active agents in the form of medicines include caffeine, salicylic acid, salicyl amide and related substances (acetylsalicylic acid, choline salicylate, magnesium salicylate, sodium salicylate), paracetamol, salts of pentazocine (pentazocine hydrochloride and pentazocinelactate), buprenorphine hydrochloride, codeine hydrochloride and codeine phosphate, morphine and morphine salts (hydrochloride, sulfate, tartrate), methadone hydrochloride, ketobemidone and salts of ketobemidone (hydrochloride), beta-blockers, (propranolol), calcium antagonists, verapamil hydrochloride, nifedinpine as well as suitable substances and salts thereof mentioned in Pharm. Int., Nov. 85, pages 267-271, Barney H. Hunter and Robert L. Talbert, nitroglycerine, erythrityl tetranitrate, strychnine and salts thereof, lidocaine, tetracaine hydrochloride, etorphine hydrochloride, atropine, insulin, enzymes (for instance papain, trypsin, amyloglucosidase. glucoseoxidase, streptokinase, streptodomase, dextranase, alpha amylase), polypeptides (oxytocin, gonadorelin, (LH. RH), desmopressin acetate (DDAVP), isoxsuprine hydrochloride, ergotamine compounds, chloroquine (phosphate, sulfate), isosorbide, demoxytocin, heparin.

Other active ingredients include beta-lupeol, Letigen, Sildenafil citrate and derivatives thereof.

Dental products include Carbami, CPP Caseine Phospho Peptide; Chlorhexidine, Chlorhexidine di acetate, Chlorhexidine Chloride, Chlorhexidine di gluconate, Hexetedine, Strontium chloride, Potassium Chloride, Sodium bicarbonate, Sodium carbonate, Fluor containing ingredients, Fluorides, Sodium fluoride, Aluminum fluoride, Ammonium fluoride, Calcium fluoride, Stannous fluoride, Other fluor containing ingredients Ammonium fluorosilicate, Potasium fluorosilicate, Sodium fluorosilicate, Ammonium monofluorphosphate, Calcium monofluorphosphate, Potassium monofluorphosphate, Sodium monofluorphosphate, Octadecentyl Ammonium fluoride, Stearyl Trihydroxyethyl Propylenediamine Dihydrofluoride, Vitamins include A, B1, B2, B6, B12, Folin acid, niacin, Pantothensyre, biotine, C, D, E, K.

Minerals include Calcium, phosphor, magnesium, iron, Zink, Cupper, Iod, Mangan, Crom, Selene, Molybden. Other active ingredients include: Q10@, enzymes. Natural drugs including Ginkgo Biloba, ginger, and fish oil. The invention also relates to use of migraine drugs such as Serotonin antagonists: Sumatriptan, Zolmitriptan, Naratriptan, Rizatriptan, Eletriptan; nausea drugs such as Cyclizin, Cinnarizin, Dimenhydramin, Difenhydrinat; hay fever drugs such as Cetrizin, Loratidin, pain relief drugs such as Buprenorfin, Tramadol, oral disease drugs such as Miconazol, Amphotericin B, Triamcinolonaceton; and the drugs Cisaprid, Domperidon, Metoclopramid.

Active ingredients may comprise the below-mentioned compounds or derivates thereof but are not limited thereto: Acetaminophen, Acetylsalicylic acid Buprenorphine Bromhexin Celcoxib Codeine, Diphenhydramin, Diclofenac, Etoricoxib, Ibuprofen, Indometacin, Ketoprofen, Lumiracoxib, Morphine, Naproxen, Oxycodon, Parecoxib, Piroxicam, Pseudoefedrin, Rofecoxib, Tenoxicam, Tramadol, Valdecoxib, Calciumcarbonat, Magaldrate, Disulfiram, Bupropion, Nicotine, Azithromycin, Clarithromycin, Clotrimazole, Erythromycin, Tetracycline, Granisetron, Ondansetron, Prometazin, Tropisetron, Brompheniramine, Ceterizin, leco-Ceterizin, Chlorcyclizine, Chlorpheniramin, Chlorpheniramin, Difenhydramine, Doxylamine, Fenofenadin, Guaifenesin, Loratidin, des-Loratidin, Phenyltoloxamine, Promethazin, Pyridamine, Terfenadin, Troxerutin, Methyldopa, Methylphenidate, Benzalcon. Chloride, Benzeth. Chloride, Cetylpyrid. Chloride, Chlorhexidine, Ecabet-sodium, Haloperidol, Allopurinol, Colchinine, Theophylline, Propanolol, Prednisolone, Prednisone, Fluoride, Urea, Miconazole, Actot, Glibenclamide, Glipizide, Metformin, Miglitol, Repaglinide, Rosiglitazone, Apomorfin, Cialis, Sildenafil, Vardenafil, Diphenoxylate, Simethicone, Cimetidine, Famotidine, Ranitidine, Ratinidine, cetrizin, Loratadine, Aspirin, Benzocaine, Dextrometorphan, Ephedrine, Phenylpropanolamine, Pseudoephedrine, Cisapride, Domperidone, Metoclopramide, Acyclovir, Dioctylsulfosucc., Phenolphtalein, Almotriptan, Eletriptan, Ergotamine, Migea, Naratriptan, Rizatriptan, Sumatriptan, Zolmitriptan, Aluminum salts, Calcium salts, Ferro salts, Silver salts, Zinc-salts, Amphotericin B, Chlorhexidine, Miconazole, Triamcinolonacetonid, Melatonine, Phenobarbitol, Caffeine, Benzodiazepiner, Hydroxyzine, Meprobamate, Phenothiazine, Buclizine, Brometazine, Cinnarizine, Cyclizine, Difenhydramine, Dimenhydrinate, Buflomedil, Amphetamine, Caffeine, Ephedrine, Orlistat, Phenylephedrine, Phenylpropanolamin, Pseudoephedrine, Sibutramin, Ketoconazole, Nitroglycerin, Nystatin, Progesterone, Testosterone, Vitamin B12, Vitamin C, Vitamin A, Vitamin D, Vitamin E, Pilocarpin, Aluminumaminoacetat, Cimetidine, Esomeprazole, Famotidine, Lansoprazole, Magnesiumoxide, Nizatide and or Ratinidine.

In one embodiment of the invention, the flavor may be used as taste masking in a toffee gum comprising active ingredients, which themselves have undesired taste or which alter the taste of the formulation.

The toffee gum may optionally contain additives, such as binding agents, acidulants, fillers, coloring agents, preservatives, and antioxidants, for instance butylated hydroxytoluene (BHT), butyl hydroxyanisol (BHA), propylgallate and tocopherols.

Colorants and whiteners may include FD & C-type dyes and lakes, fruit and vegetable extracts, titanium dioxide, and combinations thereof.

Materials to be used for the above-mentioned encapsulation methods for sweeteners might e.g. include Gelatine, Wheat protein, Soya protein, Sodium caseinate, Caseine, Gum arabic, Mod. starch, Hydrolyzed starches (maltodextrines), Alginates, Pectin, Carregeenan, Xanthan gum, Locus bean gum, Chitosan, Bees wax, Candelilla wax, Carnauba wax, Hydrogenated vegetable oils, Zein and/or Sucrose.

Generally, it is preferred that the toffee gum products prepared according to the invention are based solely on biodegradable polymers.

However, within the scope of the invention, substantially non-biodegradable natural or synthetic resins, and synthetic elastomers, examples of which are mentioned below, may be applied. Preferably, addition of the substantially non-biodegradable polymers may be restricted to relatively small amounts.

Examples of such generally substantially non-biodegradable synthetic resins include polyvinyl acetate, vinyl acetate-vinyl laurate copolymers and mixtures thereof. Examples of non-biodegradable synthetic elastomers include, but are not limited to, synthetic elastomers listed in Food and Drug Administration, CFR, Title 21, Section 172, 615, the Masticatory Substances, Synthetic) such as polyisobutylene. e.g. having a gel permeation chromatography (GPC) average molecular weight in the range of about 10,000 to 1,000,000 including the range of 50,000 to 80,000, isobutylene-isoprene copolymer (butyl elastomer), styrene-butadiene copolymers e.g. having styrene-butadiene ratios of about 1:3 to 3:1, polyvinyl acetate (PVA), e.g. having a GPC average molecular weight in the range of 2,000 to 90,000 such as the range of 3,000 to 80,000 including the range of 30,000 to 50,000, polyisoprene, polyethylene, vinyl acetate-vinyl laurate copolymer e.g. having a vinyl laurate content of about 5% to 50% by weight such as 10% to 45% by weight of the copolymer, and combinations hereof.

High- and low-molecular weight synthetic elastomers may be combined in the same polymer system. Examples of such combinations are polyisobutylene and styrene-butadiene, polyisobutylene and polyisoprene, polyisobutylene and isobutylene-isoprene copolymer (butyl rubber) and a combination of polyisobutylene, styrene-butadiene copolymer and isobutylene isoprene copolymer, and all of the above individual synthetic polymers in admixture with polyvinyl acetate, vinyl acetate-vinyl laurate copolymers, respectively and mixtures thereof.

Examples of natural resins are: Natural rosin esters, often referred to as ester gums including as examples glycerol esters of partially hydrogenated rosins, glycerol esters of polymerized rosins, glycerol esters of partially dimerised rosins, glycerol esters of tally oil rosins, pentaerythritol esters of partially hydrogenated rosins, methyl esters of rosins, partially hydrogenated methyl esters of rosins, pentaerythritol esters of rosins, synthetic resins such as terpene resins derived from alpha-pinene, beta-pinene, and/or d-limonene, and natural terpene resins.

According to an embodiment of the invention, the polymer system may comprise natural or synthetic resins or elastomers, such as for example glycerol esters, polyvinyl acetate or butyl rubber, in an amount in the range of 0% to 30%, preferably 0% to 20%, and most preferably less than 5% by weight of the polymer system.

According to an embodiment of the invention, e.g. polyvinyl acetate may be applied in a limited amount in the polymer system in order to correct the toffee gum texture. However, polyvinyl acetate is generally not a preferred ingredient in the biodegradable toffee gum of the present invention, as it is lacking the desired biodegradability.

In general, a toffee gum product according to the invention may be manufactured by sequentially adding the various ingredients to a commercially available mixer. After the ingredients have been thoroughly mixed, the toffee gum mass is discharged from the mixer and shaped into the desired form such as by rolling into sheets and cutting into sticks, extruded into chunks or casting into pellets.

A typical example of the mixing procedure may in an embodiment of the invention involve the following. Generally, the ingredients may be mixed by first melting and then mixing the polymer system. The softening agents or part of them may also be added at this time. Colors, active agents and/or emulsifiers may then be added, along with syrup and a portion of the bulking agent/sweetener. Further portions of the bulking agent/sweetener may then be added into the mixer. A flavoring agent may typically be added with the final portion of the bulking agent/sweetener. A high-intensity sweetener may preferably be added after the final portion of bulking agent.

The entire mixing procedure typically takes from five to fifteen minutes, but longer mixing times may sometimes be required. Many variations of the above-described procedure may be followed, including a one-step method such as described in US patent application 2004/0115305, hereby incorporated as reference. Toffee gum products may be formed by extrusion, compression, rolling and may be center-filled with liquids and/or solids in any form.

According to a preferred embodiment of the invention, the toffee gum is manufactured by an extrusion process.

The toffee gum according to the present invention may also be provided with an outer coating, which may be a hard coating, a soft coating, a film coating, or a coating of any type that is known in the art, or a combination of such coatings. The coating may typically constitute 0.1 to 75 percent by weight of a coated toffee gum product.

One preferred outer coating type is a hard coating, which term is including sugar coatings and sugar-free (or sugarless) coatings and combinations thereof. The object of hard coating is to obtain a sweet, crunchy layer, which is appreciated by the consumer and to protect the center of the product. In a typical process of providing the toffee gum with a protective sugar coating they are successively treated in suitable coating equipment with aqueous solutions of crystallisable sugar such as sucrose or dextrose, which, depending on the stage of coating reached, may contain other functional ingredients, e.g. fillers, colors, etc.

In one presently preferred embodiment, the coating agent applied in a hard coating process is a sugarless coating agent, e.g. a polyol including as examples sorbitol, maltitol, mannitol, xylitol, erythritol, lactitol and isomalt or e.g. a mono-di-saccharide including as example trehalose.

Or alternatively a sugar free soft coating prepared by alternately applying to the product surface a syrup of a polyol or a mono-di-saccharide, including as examples sorbitol, maltitol, mannitol, xylitol, erythritol, lactitol, isomalt and trehalose.

According to an embodiment of the invention, the biodegradable toffee gum may be coated with chocolate according to conventional chocolate coating processes.

In further useful embodiments a film coating is provided by film-forming agents such as a cellulose derivative, a modified starch, a dextrin, gelatine, zein, shellec, gum arabic, a vegetable gum, a synthetic polymer, etc. or a combination thereof.

In an embodiment of the invention, the outer coating comprises at least one additive component selected from the group comprising a binding agent, a moisture-absorbing component, a film-forming agent, a dispersing agent, an antisticking component, a bulking agent, a flavoring agent, a coloring agent, a pharmaceutically or cosmetically active component, a lipid component, a wax component, a sugar, and an acid.

A coated toffee gum product according to the invention may have any form, shape or dimension that permits the toffee gum to be coated using any conventional coating process. Accordingly, the product may be e.g. in a form selected from a pellet, a cushion-shaped pellet, a stick, a tablet, a chunk, a pastille, a pill, a ball and a sphere, and typically the weight of uncoated product may be 0.5 to 10 grams.

The following non-limiting examples illustrate the manufacturing of a toffee gum confectionery product according to the invention.

### Example 1

### Manufacturing of Polymers

Different biodegradable polymers for application in toffee gums of the invention were prepared according to the descriptions given here below.

### Polymer No. 101

A biodegradable resin sample is produced using a cylindrical glass, jacketed 10 L pilot reactor equipped with glass stir shaft and Teflon stir blades and bottom outlet. Heating of the reactor contents is accomplished by circulation of silicone oil, thermo stated to 130° C., through the outer jacket. ε-caprolactone (358.87 g, 3.145 mol) and 1,2-propylene glycol (79.87 g, 1.050 mol) are charged to the reactor together with stannous octoate (1.79 g, 4.42×10⁻³ mol) as the catalyst and reacting in about 30 min. at 130° C. Then molten D,L-lactide (4.877 kg, 33.84 mol) are added and reaction continued for about 2 hours. At the end of this period, the bottom outlet is opened, and molten polymer is allowed to drain into a Teflon-lined paint can. Characterization of the product indicates Mₙ=6,500 g/mol and M_{w}=7,100 g/mol (gel permeation chromatography with online MALLS detector) and Tg=31° C. (DSC, heating rate 10° C./min).

### Polymer No. 102

A biodegradable resin sample is produced similarly to polymer no. 102, but with a higher molecular weight. Characterization of the product indicates Mₙ=19,380 g/mol and M_{w}=21,150 g/mol (gel permeation chromatography with online MALLS detector) and T_{g}=32° C. (DSC, heating rate 10° C./min).

### Polymer No. 103

A biodegradable elastomer sample is produced using a 500 mL resin kettle equipped with an overhead stirrer, nitrogen gas inlet tube, thermometer, and distillation head for removal of methanol. To the kettle are charged 83.50 g (0.43 mole) dimethyl terephthalate, 99.29 g (0.57 mole) dimethyl adipate, 106.60 g (1.005 mole) di(ethylene glycol) and 0.6 g calcium acetate monohydrate. Under nitrogen, the mixture is slowly heated with stirring until all components become molten (120-140° C.). Heating and stirring are continued and methanol is continuously distilled. The temperature slowly rises in the range 150-200° C. until the evolution of methanol ceases. Heating is discontinued and the content is allowed to cool to about 100° C. The reactor lid is removed and the molten polymer is carefully poured into a receiving vessel.

Characterization of the polymer indicates Tg=−30° C. (DSC, heating rate 10° C./min), Mn=40,000 g/mol and Mw=190,000 g/mol (gel permeation chromatography with online MALLS detector).

### Polymer No. 104

A biodegradable resinous polymer with molar ratio of 97% D,L-lactide and 3% ε-caprolactone initiated with 1,2-propane diol is produced in the following manner. To a dry 100 ml glass round-bottom flask was charged 0.265 g Tin(II)-ethylhexanoate (Aldrich 97%), 6.427 g 1,2-propanediol (Aldrich 99+%), and 18.627 g ε-caprolactone (ACROS 99+%) in a dry, nitrogen purged glove-box. The reactor was immersed into a 130° C. preheated silicone oil bath and mechanically stirred for 65 minutes and removed from the oil bath. The polymer was drawn into a dry syringe while still hot and 22.172 g was charged into a dry 1000 ml round-bottom flask containing 678.062 g D,L-lactide (ORTEC). The flask was immersed into the 130° C. preheated silicone oil bath and mechanically stirred for 300 minutes when removed. The flask was immediately removed from the glove-box and completely wrapped with a pre-heated Glas-Col 500 watts/115 volts heating mantle regulated with a Staco Energy Products Type 3 Variable Autotransformer set at 65% of 0-120V output. The heated vessel was inverted allowing the final polymer product to fully discharge from the reactor within approximately 2 minutes into a dry 1-quart metal packaging container. Characterization of the polymer indicates Tg=44° C. (DSC, heating rate 10° C./min), Mₙ=11,650 g/mol, and M_{w}=12,420 g/mol (gel permeation chromatography with online MALLS detector). PD=1.07.

### Polymer No. 105

A biodegradable resinous polymer with molar ratio of 96.5% D,L-lactide and 3.5% ε-caprolactone initiated with 1,2-propane diol is produced in substantially the same way as described for polymer no. 104 and as outlined in the following.

To a dry 100 ml glass round-bottom flask was charged 0.252 g Tin(II)-ethylhexanoate (Aldrich 97%), 3.198 g 1,2-propanediol (Aldrich 99+%), and 23.366 g ε-caprolactone (ACROS 99+%) in a dry, nitrogen purged glove-box. The reactor was immersed into a 130° C. preheated silicone oil bath and mechanically stirred for 65 minutes and removed from the oil bath. The polymer was drawn into a dry syringe while still hot and 22,344 g was charged into a dry 1000 ml round-bottom flask containing 677,871 g D,L-lactide (ORTEC). The flask was immersed into the 130° C. preheated silicone oil bath and mechanically stirred for 320 minutes when removed. The flask was immediately removed from the glove-box and completely wrapped with a pre-heated Glas-Col 500 watts/115 volts heating mantle regulated with a Staco Energy Products Type 3 Variable Autotransformer set at 65% of 0-120V output. The heated vessel was inverted allowing the final polymer product to fully discharge from the reactor within approximately 2 minutes into a dry 1-quart metal packaging container. Characterization of the polymer indicates Tg=41° C. (DSC, heating rate 10° C./min), Mn=20,350 g/mol, and Mw=23,480 g/mol (gel permeation chromatography with online MALLS detector). PD=1.15.

### Polymer No. 106

A biodegradable resinous homo-polymer of L-lactide is produced substantially in the same way as described for the polymers no. 104 and 105. By the polymerization, a biodegradable resinous polymer is prepared from only one monomer type, L-lactide, and the resulting polymer is a 100%-lactide polymer.

Characterization of the polymer indicates Tg about 40° C. (DSC, heating rate 10° C./min), Mn=6,329 g/mol and Mw=6,536 g/mol (gel permeation chromatography with online MALLS detector).

### Example 2

### Preparation of Toffee Gums

The polymers of example 1 were employed in a series of polymer systems, which were applied in toffee gum products according to embodiments of the invention.

The prepared polymer systems are outlined in table 1, and the preparation involved simply processing of the polymer or polymers of each composition in a mixer, such as e.g. a Z-blade mixing kettle. The mixing process was carried out at a temperature of about 50-80° C. for a period of about 10-20 minutes, thereby preparing a homogeneous mixture of each polymer system. In case, one single polymer constitutes the polymer system, the mixing procedure serves yet to modify the polymer texture prior to the application in a toffee gum according to the invention. The mixing process, the heating, and a possible softening agent all contribute to a softening of the polymer system prior to mixing of the final toffee gum composition.

The mixed polymer system may be discharged from the mixer and allowed to cool to room temperature before transferring into a second mixer. Alternatively, the mixed polymer system may be transferred in its heated state into a second mixer, or the polymer system may be kept within the first mixer ready for addition of the further ingredients to prepare the toffee gum.

TABLE 1
Polymer system compositions. Numbers are given in percentage by weight of the
total polymer system.

| | Polymer system no. | | | | | | | | | |
|---|---|---|---|---|---|---|---|---|---|---|
| Components | 1011 | 1012 | 1013 | 1014 | 1015 | 1016 | 1017 | 1018 | 1019 | 1020 |
| Polymer no. 101 | 100 | 98 | 94 | 94 | 94 | 99 | 95 | | | |
| Polymer no. 102 | | | 2 | 2 | 2 | | | | | |
| Polymer no. 103 | | | | | | 1 | 5 | | | |
| Polymer no. 104 | | | | | | | | 100 | | |
| Polymer no. 105 | | | | | | | | | 100 | |
| Polymer no. 106 | | | | | | | | | | 100 |
| Softener (triacetin) | | 2 | 4 | | | | | | | |
| Softener (acetylated | | | | 4 | | | | | | |
| monoglyceride) | | | | | | | | | | |
| Softener (mono-di- | | | | | 4 | | | | | |
| glyceride) | | | | | | | | | | |

The different polymer systems were applied within comparable overall toffee gum compositions prepared according to the following formulation (percentages are given by weight of the total toffee gum composition):

| | |
|---|---|
| Polymer system | 40% |
| Sorbitol powder | 37.1% |
| Maltitol syrup | 14% |
| Flavor (liquid) | 1.5% |
| Flavor (crystals) | 0.5% |
| High-intensity sweeteners | 0.4% |
| Xylitol powder | 6% |
| Softener | 0.5% |

The components are all mixed together in a mixer at a temperature of about 40-60° C. A mixing kettle, e.g. with horizontally placed Z-shaped arms may for example be used. Initially, the polymer system and about half of the sorbitol powder are mixed for about 3 minutes. At this time, the mixer should preferably be at the required temperature of 40-60° C. If necessary, the mixer may be preheated, e.g. for about 15 minutes. After mixing the polymer system and the first half portion of the sorbitol, flavors are added and mixing is continued for 1 minute, whereupon the remaining half portion of sorbitol is added and mixed for 1 minute. Maltitol syrup is then added, and the composition is mixed well. Softener is slowly added and mixed for about 7 minutes. Then high-intensity sweeteners are added and mixed for 3 minutes. Xylitol is added and mixing continued for 3 minutes, whereupon the resulting toffee gum composition is discharged and e.g. transferred to a pan at a temperature of 40-48° C. The product is then rolled and scored into cores, sticks, balls, cubes, and any other desired shape, optionally followed by coating and polishing processes prior to packaging.

Evidently, within the scope of the invention, other processes and ingredients may be applied in the process of manufacturing the toffee gum.

### Example 3

### Evaluation of the Prepared Toffee Gums

Samples of toffee gums comprising the different polymer systems were tested by a panel of individual test persons, whereby the following evaluation was obtained.

All the toffee gum products were evaluated to be acceptable with regard to toffee-like texture and chewing phases. The toffee gum products had the desired toffee-like consistency when applying any of the polymer systems no. 1011, 1012, 1013, 1014, 1015, 1016, 1018, 1019, and 1020.

Only the samples comprising polymer system no. 1017 were evaluated to be hardly acceptable, since the toffee gum possessed features reminding more of chewing gum than of toffee. In other words, the toffee gum had some resemblance with chewing gum, which is interpreted to be due to the content of elastomers being higher in 1017 compared to the content of elastomers in the other polymer systems, which were applied in the rest of the toffee gum products.

The test panel concluded that all the evaluated toffee gum products comprising polymer system no. 1011 to 1020, except 1017, had the desired toffee-like texture and chewing phases, although some variations in texture were observed.

It should be noted that toffee gum products comprising higher or lower percentages of polymer system may be prepared and have the desired properties as obtained by the toffee gums of example 2. Similar toffee gums may be prepared with polymer systems comprising e.g. 20%, 60% or 80% of the toffee gum composition. For obtaining the desired properties, the most favourable percentages of polymer system may be found within the range of 30% to 60% by weight polymer system in the final toffee gum confectionery product. By a relatively low percentage, such as 20% polymer system, a product may be provided having a great deal of sweetness and flavor and leaving only a relatively small amount of gum being retained in the mouth. On the contrary, by a relatively high percentage, such as 80% polymer system, a product may be provided of which a relatively large amount of gum is retained in the mouth, but the sweetness and flavor of such a product is not as marked and pronounced as the products prepared and evaluated in examples 2-3.

1. A toffee gum comprising
a polymer system,
at least one flavor, and
at least one sweetener,
said polymer system constituting at least 10% by weight of said toffee gum,
at least 70% by weight of said polymer system comprising one or more at least partly biodegradable polymers, and
at least one of said at least partly biodegradable polymers having a molecular weight (Mn) in the range of 1000 to 250000 g/mol.

2. A toffee gum according to claim 1, wherein said polymer system is substantially free of elastomers.

3. A toffee gum according to claim 1, wherein said polymer system constitutes at least 12% by weight of said toffee gum.

4. A toffee gum according to claim 1, wherein said polymer system constitutes in the range of 15% to 95% by weight of said toffee gum.

5. A toffee gum according to claim 1, wherein said polymer system comprises at least one non-elastomeric polymer.

6. A toffee gum according to claim 1, wherein said polymer system comprises at least one elastomeric polymer.

7. A toffee gum according claim 5, wherein said at least one non-elastomeric polymer constitutes in the range of 70% to 100% by weight of said polymer system.

8. A toffee gum according to claim 6, wherein said at least one elastomeric polymer constitutes in the range of 0% to 30% by weight of said polymer system.

9. A toffee gum according to claim 6, wherein said at least one elastomeric polymer has a molecular weight in the range of 10000 to 500000 g/mol.

10. A toffee gum according claim 1, wherein said polymer system comprises polymers having a molecular weight (Mn) from about 50000 to 250000 g/mol in an amount of less than 8% by weight of said polymer system.

11. A toffee gum according to claim 1, wherein said polymer system comprises polymers having a molecular weight (Mn) from about 250000 to 500000 g/mol in an amount of less than 4% by weight of said polymer system.

12. A toffee gum according to claim 1, wherein at least one of said at least partly biodegradable polymers has a molecular weight (Mn) in the range of about 1000 to 250000 g/mol.

13. A toffee gum according to claim 1, wherein at least one of said at least partly biodegradable polymers is a polyester polymer.

14. A toffee gum according to claim 1, wherein said at least partly biodegradable polymers comprise at least one polyester polymer obtainable by polymerization of at least one cyclic ester.

15. A toffee gum according to claim 14, wherein at least one of said at least one cyclic ester is selected from the group consisting of glycolides, lactides, lactones, cyclic carbonates and mixtures thereof.

16. A toffee gum according to claim 15, wherein at least one of said lactone monomers is selected from the group consisting of ε-caprolactone, δ-valerolactone, γ-butyrolactone, β-propiolactone, substituted ε-caprolactones, substituted δ-valerolactones, substituted γ-butyrolactones, and substituted β-propiolactones, wherein the substituted monomers have been substituted with one or more alkyl or aryl substituents at any non-carbonyl carbon atoms along the ring, including compounds in which two substituents are contained on the same carbon atom.

17. A toffee gum according to claim 15, wherein at least one of said carbonate monomers is selected from the group consisting of trimethylene carbonate, 5-alkyl-1,3-dioxan-2-one, 5,5-dialkyl-1,3-dioxan-2-one, 5-alkyl-5-alkyloxycarbonyl-1,3-dioxan-2-one, ethylene carbonate, propylene carbonate, trimethylolpropane monocarbonate, 4,6-dimethyl-1,3-propylene carbonate, 2,2-dimethyl trimethylene carbonate, 1,3-dioxepan-2-one and mixtures thereof.

18. A toffee gum according to claim 14, wherein said at least one polyester polymer obtainable by polymerization of at least one cyclic ester is selected from the group consisting of poly (L-lactide), poly (D-lactide), poly (D, L-lactide), poly (mesolactide), poly (glycolide), poly (trimethylenecarbonate), poly (epsilon-caprolactone), poly (L-lactide-co-D, L-lactide), poly (L-lactide-co-mesolactide), poly (L-lactide-co-glycolide), poly (L-lactide-co-trimethylenecarbonate), poly (L-lactide-co-epsilon-caprolactone), poly (D, L-lactide-co-meso-lactide), poly (D, L-lactide-co-glycolide), poly (D, L-lactide-co-trimethylenecarbonate), poly (D, L-lactide-co-epsilon-caprolactone), poly (meso-lactide-co-glycolide), poly (meso-lactide-co-trimethylenecarbonate), poly (meso-lactide-co-epsilon-caprolactone), poly (glycolide-cotrimethylenecarbonate), poly (glycolide-co-epsilon-caprolactone), and any combination thereof.

19. A toffee gum according to claim 1, wherein said at least partly biodegradable polymers comprise at least one polyester polymer obtainable by condensation polymerization of at least one polyfunctional alcohol or derivative thereof and at least one polyfunctional acid or derivative thereof.

20. A toffee gum according to claim 19, wherein said at least one polyfunctional acid is selected from the group consisting of oxalic acid, malonic acid, citric acid, succinic acid, malic acid, tartaric acid, fumaric acid, maleic acid, glutaric acid, glutamic acid, adipic acid, glucaric acid, pimelic acid, suberic acid, azelaic acid, sebacic acid, dodecanedioic acid, cyclopropane dicarboxylic acid, cyclobutane dicarboxylic acid, cyclohexane dicarboxylic acid, terephthalic acid, isophthalic acid, phthalic acid, trimellitic acid, pyromellitic acid, naphthalene 1,4-dicarboxylic acid, naphthalene 2,3-dicarboxylic acid, naphthalene 2,6-dicarboxylic acid, and any combination thereof.

21. A toffee gum according to claim 19, wherein said at least one polyfunctional alcohol is selected from the group consisting of ethylene glycol, 1,2-propanediol, 1,3-propanediol, 1,3-butanediol, 1,4-butanediol, 1,6-hexanediol, diethylene glycol, 1,4-cyclohexanediol, 1,4-cyclohexanedimethanol, neopentyl glycol, glycerol, trimethylolpropane, pentaerythritol, sorbitol, mannitol, and any combination thereof.

22. A toffee gum according to claim 19, wherein said polyester is obtainable through reaction of at least one acid or derivative thereof selected from the group consisting of terephthalic, phthalic, adipic, pimelic, succinic, and malonic acids with at least one alcohol or derivative thereof selected from the group consisting of methylene, ethylene, propylene, and butylene diols.

23. A toffee gum according to claim 1, wherein said at least partly biodegradable polymers constitute at least 80% by weight of said polymer system.

24. A toffee gum according to claim 1, wherein at least 70% by weight of said at least partly biodegradable polymers have molecular weights (Mn) in the range of 2000 to 100000 g/mol.

25. A toffee gum according to claim 1, wherein at least 70% by weight of said at least partly biodegradable polymers have glass transition temperatures (Tg) in the range of 0 to 60° C.

26. A toffee gum according to claim 1, wherein at the most 30% by weight of said at least partly biodegradable polymers have molecular weights (Mn) in the range of 100000 to 500000 g/mol.

27. A toffee gum according to claim 1, wherein at the most 30% by weight of said at least partly biodegradable polymers have glass transition temperatures (Tg) in the range of −1 to −100° C.

28. A toffee gum according to claim 1, wherein said polymer system comprises at least 70% of biodegradable polymers having molecular weights (Mn) in the range of 2000 to 100000 g/mol and glass transition temperatures (Tg) in the range of 0 to 60° C.

29. A toffee gum according to claim 1, wherein said polymer system comprises at least 95% of biodegradable polymers having molecular weights (Mn) in the range of 2000 to 100000 g/mol and glass transition temperatures (Tg) in the range of 0 to 60° C.

30. A toffee gum according to claim 1, wherein said polymer system substantially consists of biodegradable polymers having molecular weights (Mn) in the range of 2000 to 100000 g/mol and glass transition temperatures (Tg) in the range of 0 to 60° C.

31. A toffee gum according to claim 1, wherein at least one of said at least partly biodegradable polymers is non-elastomeric.

32. A toffee gum according to claim 31, wherein at least one of said at least partly biodegradable non-elastomeric polymers has a molecular weight in the range of 2000 to 200000 g/mol.

33. A toffee gum according to claim 31, wherein at least one of said at least partly biodegradable non-elastomeric polymers has a glass transition temperature (Tg) in the range of −10 to 100° C.

34. A toffee gum according to claim 3, wherein said at least partly biodegradable non-elastomeric polymers constitute in the range of 70% to 100% by weight of said polymer system.

35. A toffee gum according to claim 1, wherein at least one of said at least partly biodegradable polymers is elastomeric.

36. A toffee gum according to claim 35, wherein at least one of said at least partly biodegradable elastomeric polymers has a molecular weight in the range of 10000 to 250000 g/mol.

37. A toffee gum according to claim 35, wherein at least one of said at least partly biodegradable elastomeric polymers has a glass transition temperature (Tg) in the range of −1 to −100° C.

38. A toffee gum according to claim 35, wherein said at least partly biodegradable elastomeric polymers constitute in the range of 0% to 30% by weight of said polymer system.

39. A toffee gum according to claim 1, wherein said toffee gum comprises at least one softener in an amount in the range of 0.5% to 25% by weight of said toffee gum.

40. A toffee gum according to claim 39, wherein at least a part of said softener is incorporated in the polymer system.

41. A toffee gum according to claim 39, wherein said at least one softener is selected from the group consisting of triacetin, lecithin, acetylated glycerides, mono- and di-glycerides, and any combination thereof.

42. A toffee gum according to claim 1, wherein said toffee gum comprises at least one syrup of a polyol in an amount of 1% to 25% by weight of said toffee gum.

43. A toffee gum according to claim 1, wherein the toffee gum comprises less than 6% by weight of filler.

44. A toffee gum according to claim 1, wherein the toffee gum is substantially free of filler.

45. A toffee gum according to claim 1, wherein said toffee gum comprises at said least one flavor in an amount of about 0.00 1% to 30% by weight, and said at least one sweetener in an amount of about 5% to 80% by weight.

46. A toffee gum according to claim 45, wherein said at least one flavor is substantially oil-based and/or substantially hydrophilic flavors.

47. A toffee gum according to claim 1, wherein said at least one sweetener is a sugar.

48. A toffee gum according to claim 1, wherein said at least one sweetener is an artificial sweetener.

49. A toffee gum according to claim 48, wherein said artificial sweetener is selected from the group consisting of sorbitol, mannitol, maltitol, xylitol, erythritol, lactitol, isomalt, derivatives of isomalt, and any combination thereof.

50. A toffee gum according to claim 48, wherein said artificial sweetener is a high-intensity artificial sweetener selected from the group consisting of aspartame, salts of acesulfame, alitame, neotame, twinsweet, saccharin and its salts, cyclamic acid and its salts, glycyrrhizin, dihydrochalcones, thaumatin, monellin, stevioside, sucralose, and any combination thereof.

51. A toffee gum according to claim 1, further comprising active ingredients.

52. A toffee gum according to claim 1, wherein said toffee gum forms a tablet comprising a chewable polymer system.

53. A toffee gum according to claim 1, wherein said toffee gum is formed in shapes selected from the group consisting of cores, ellipsoid, balls, cylinders, squares, rectangular, hexagonal, strips, paraboloid, donut formed, ring formed, teddy bear formed multi-modular, and any combination thereof.

54. A toffee gum according to claim 1, wherein said toffee gum weighs from about ¼ gram to about 10 grams.

55. A toffee gum according to claim 1, wherein said toffee gum weighs from about ½ gram to about 5 grams.

56. A toffee gum according to claim 1, wherein said toffee gum is provided with an outer coating.

57. A toffee gum according to claim 56, wherein said coating is selected from the group consisting of hard coating, soft coating and edible film-coating.

58. A toffee gum according to claim 56, wherein said coating comprises chocolate.

59. A toffee gum according to claim 1, wherein said toffee gum is center-filled.

60. A toffee gum according to claim 1, wherein said toffee gum is compressed.

61. Method of manufacturing a toffee gum according to claim 1, comprising
manufacturing the toffee gum by a batch process.

62. Method of manufacturing a toffee gum according to claim 1, comprising
manufacturing the toffee gum by an extruder process.
